(19) United States
(12) Patent Application Publication
(10) Pub. No.: US 2009/0288516 A1
(43) Pub. Date: Nov. 26, 2009

(54) Control Structure for a Two-Way Ratchet Tool

(76) Inventor: Shu-Su ZHAN, Taichung City (TW)

Correspondence Address: Dr. BANGER SHIA, 102 Lindencrest Ct., Sugar Land, TX, 77479-5201, US

(21) Appl. No.: 12/422,277

(22) Filed: Apr. 12, 2009

(30) Foreign Application Priority Data
May 23, 2008 (TW) 097209014

(51) Int. Cl. G05G 1/08

(52) U.S. Cl. 74/577 M

(57) ABSTRACT

A control structure for a two-way ratchet tool comprises a handle, an adjustment member, a ratchet member and a control member. The handle includes a shank portion, a drive portion and a ratchet portion including a positioning groove, a sliding surface and a protruding stop ring. The sliding surface includes an arc groove for accommodation of an elastic member, and the positioning groove includes an adjustment recess for accommodation of a push member and a spring. The adjustment member includes plural teeth on an upper end thereof and an adjustment rod at one side thereof. The ratchet member includes a smooth surface and a toothed surface on an outer periphery thereof and a wavy engaging surface on an inner periphery thereof. The control member includes a ring body with a wavy outer surface and a control end, the ring body includes a locking groove for accommodation of a C-shaped clip, and a limiting recess.

### BACKGROUND OF THE INVENTION

1. Field of the Invention

The present invention relates to a control structure for a two-way ratchet tool, which utilizes an adjustment member to limit the rotation of the ratchet member to a single direction and utilizes an elastic member disposed in an arc groove to make the contact between the ratchet member and the adjustment member much closer, and utilizes a push member and an elastic member to increase a torque capacity of the ratchet member for preventing the ratchet member from rotating in both clockwise and counterclockwise directions.

2. Description of the Prior Art

Referring to FIG. 8, a conventional control structure for a two-way ratchet tool essentially comprises a handle 50, a control member 60, an adjuster 70 and a ratchet member 80. The handle 50 includes a ratchet portion 51 and a shank portion 52. The ratchet portion 51 is defined with an opening which is defined with a positioning groove 53 around an inner periphery thereof. The ratchet portion 51 is further defined with an arc groove 54 adjacent to the shank portion 52. Between the shank portion 52 and the ratchet portion 51 is defined a through control hole 55. The control hole 55 is defined with a positioning recess 56 in one side thereof. The arc groove 54 communicates with the control hole 55. The control member 60 is formed with a downward-extended control pin 61 which is defined with a fan through hole 62. The adjuster 70 includes an adjustment member 71, a push member 72, an elastic member 73 and a control rod 74. The adjustment member 71 is an arc block provided with a toothed surface 711 on one end thereof and a positioning recess 712 in the other end thereof. The elastic member 73 is biased between the push member 72 and the control rod 74. The ratchet member 80 is an annular member provided with a toothed portion 81 and an annular groove 82 around an outer periphery thereof. The ratchet member 80 is further provided with an engaging surface 83 on an inner periphery thereof. The annular groove 82 is provided for receiving a C-shaped clip 84, and the control member 60 is fitted into the control hole 55. The control rod 74, the elastic member 73 and the push member 72 are inserted through the fan through hole 62 from the arc groove 54 to resist against the positioning recess 56. The adjustment member 71 is disposed in the arc groove 54 with its toothed surface 711 facing outwards. The ratchet member 80 is engaged in the ratchet portion 51. Between the annular groove 82 and the positioning groove 53 is disposed the C-shaped clip 84.

When in practical use, turning the control member 60 left or right will pull the control rod 74. Since the control rod 74 is connected with the elastic member 73 and the push member 72 which is limited in the positioning recess 712 of the adjustment member 71, the adjustment member 71 can be rotated left or right by the control rod 74. The adjustment member 71 is limited by the push member 72 and the arc groove 54, and the toothed surface 711 of the adjustment member 71 is engaged with the toothed portion 81, so that the ratchet member 80 can only rotate in a single direction to screw or unscrew a nut. As known from the above description, it can be found that the above conventional control structure for a two-way ratchet tool has the following disadvantages: the adjustment member 71 is directly pressed against the ratchet member 80 by the elastic force of the elastic member 73 which is prone to having fatigue problem after a long period of use or due to uneven forces, making the adjustment member 71 unable to engage with the ratchet member 80. Therefore, the ratchet member 80 can rotate in both clockwise and counterclockwise directions, thus losing the screwing and unscrewing functions.

The present invention has arisen to mitigate and/or obviate the afore-described disadvantages.

### SUMMARY OF THE INVENTION

The technical problems to be solved:

In a conventional ratchet tool, the adjustment member is directly pressed against the ratchet member by the elastic force of the elastic member which is prone to having fatigue problem after a long period of use or due to uneven forces, making the adjustment member unable to engage with the ratchet member, therefore the ratchet member can rotate in both clockwise and counterclockwise directions, thus losing the screwing and unscrewing functions.

In order to solve the above technical problems, a control structure for a two-way ratchet tool in accordance with the present invention comprises: a handle, an adjustment member, a ratchet member and a control member. The handle is connected with a ratchet portion having an adjustment recess provided with a spring and a push member. In an arc groove of the ratchet portion is installed an elastic member. The adjustment member is disposed in the arc groove with its teeth facing upwards and its resisting surface pressing against the elastic member in the arc groove. The adjustment member has an adjustment rod located in an upper end of the adjustment recess, and the lower end of the adjustment rod resists against the push member. The ratchet member is disposed in an opening of the ratchet portion and has a toothed surface located on a sliding surface of the ratchet portion and a smooth surface disposed at the positioning groove. The teeth of the adjustment member are engaged with the toothed surface of the ratchet member. Further, one side of the ratchet member is limited by a stop ring, and the control member has a locking groove provided with a C-shaped clip. The control member is installed in from one side of the positioning groove of the ratchet portion and presses the C-shaped clip to slide into the positioning groove, thus limiting the control member and the ratchet member within the ratchet portion. In addition, the adjustment rod of the adjustment member is disposed in a limiting recess in the control member. By such arrangements, when the control end is turned right, since the adjustment rod is limited in the limiting recess, the adjustment member will be turned right within the arc groove of the ratchet portion and then positioned against the push member. At the same time, the teeth of the adjustment member are engaged with the toothed surface of the ratchet member, and the adjustment member is limited by the arc groove and the elastic member, so that when the handle is turned in the clockwise direction, the ratchet member cannot rotate in the counterclockwise direction, and the nut will be screwed in the clockwise direction. When being rotated in a reversed direction, namely in the clockwise direction, the ratchet member will push the adjustment member towards the center of the arc groove to make the toothed surface disengage from the teeth, so that when the handle is turned in the counterclockwise direction, the ratchet member can rotate along the sliding surface without unscrewing the nut. As compared to the conventional control structure, the present invention has the following advantages:

Turning the handle left and right can screw a nut. The adjustment member is limited at a left side or right side of the arc groove so as to allow the ratchet member to rotate in a single direction to screw or unscrew the nut. The elastic member is disposed in the arc groove and supports against the lower end of the adjustment member to make the contact between the adjustment member and the ratchet member much closer. The push member cooperates with the elastic member to increase the torque capacity of the ratchet member for preventing the ratchet member from rotating in both clockwise and counterclockwise directions.

### BRIEF DESCRIPTION OF THE DRAWINGS

FIG. 1 is a perspective view of a control structure for a two-way ratchet tool in accordance with the present invention;

FIG. 2 is an exploded view of the control structure for a two-way ratchet tool in accordance with the present invention;

FIG. 3 is a perspective cross-sectional view of the control structure for a two-way ratchet tool in accordance with the present invention;

FIG. 4 is a side cross-sectional view of the control structure for a two-way ratchet tool in accordance with the present invention;

FIG. 5 is a perspective view showing the adjustment member and the control member in accordance with the present invention;

FIG. 6 is a schematic view showing a screwing operation in accordance with the present invention;

FIG. 7 is a schematic view showing an unscrewing operation in accordance with the present invention; and

FIG. 8 is an exploded view of a conventional ratchet structure.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

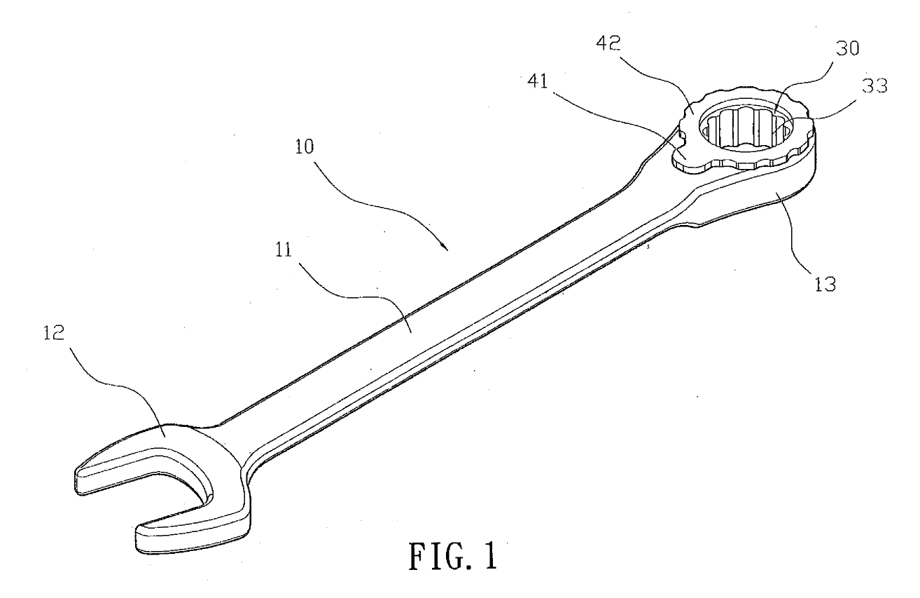

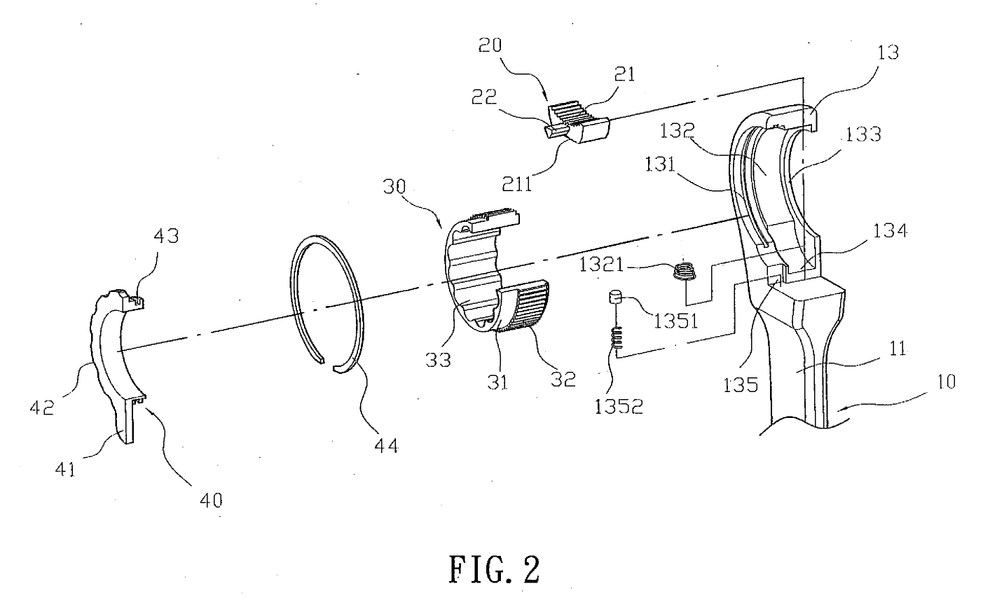

Referring to FIGS. 1 and 2, a control structure for a two-way ratchet tool in accordance with a preferred embodiment of the present invention comprises: a handle 10, an adjustment member 20, a ratchet member 30 and a control member 40. The handle 10 includes a shank portion 11, a drive portion 12 and a ratchet portion 13. The shank portion 11 is connected between the drive portion 12 and the ratchet portion 13. The drive portion 12 is a turning end of a hand tool. The ratchet portion 13 is an annular opening which is provided in an inner periphery thereof with a positioning groove 131. The ratchet portion 13 is further provided with a sliding surface 132 at an inner side of the positioning groove 131 (namely the positioning groove 131 is located at one side of the sliding surface 132) on the inner periphery thereof, and a protruding stop ring 133 at the other side of the sliding surface 132. The sliding surface 132 of the ratchet portion 13 is defined with an arc groove 134 adjacent to the shank portion 11 for accommodation of an elastic member 1321 which can be a coil spring, a leaf spring or rubber. The positioning groove 131 of the ratchet portion 13 is defined with an adjustment recess 135 located close to the shank portion 11. In the adjustment recess 135 is provided a push member 1351 and a spring 1352. The adjustment member 20 is an arc block provided with plural teeth 21 on an upper end thereof and a resisting surface 211 on a lower end thereof. The adjustment member 20 is formed with an adjustment rod 22 extending from one side thereof, and the adjustment rod 22 is triangular in cross section. The ratchet member 30 is an annular member formed with a smooth surface 31 and a toothed surface 32 on an outer periphery thereof. The ratchet member 30 is further provided with a wavy engaging surface 33 on an inner periphery thereof. The control member 40 includes a ring body 42 with a wavy outer surface and a control end 41 extending from the ring body 42. The ring body 42 is defined with a locking groove 43 in one side thereof for accommodation of a C-shaped clip 44. The ring body 42 is further defined with a limiting recess 45 vertical to the locking groove 43 in alignment with the control end 41.

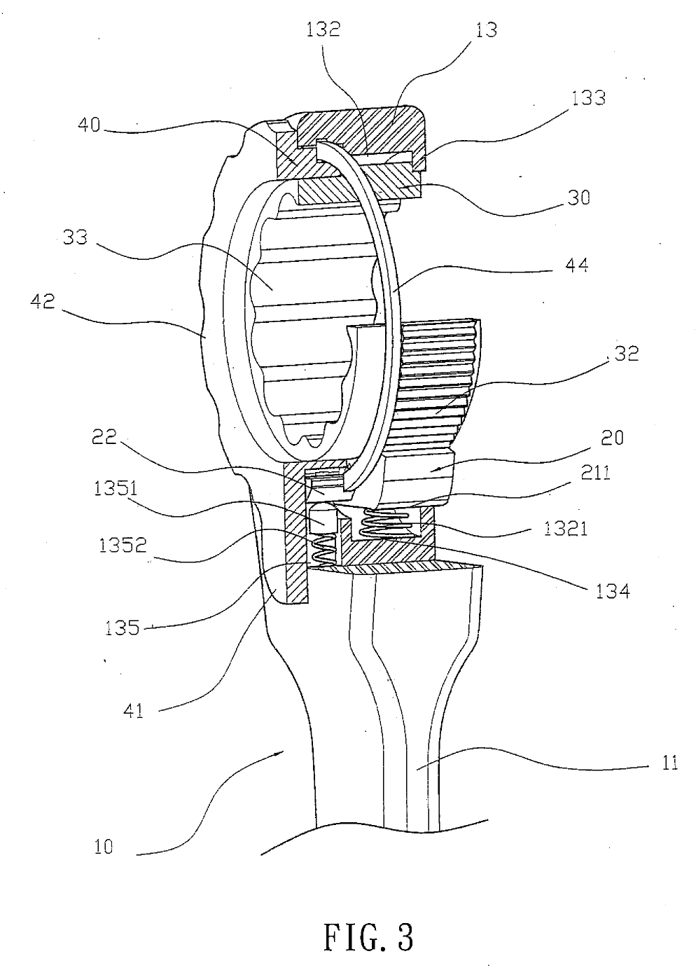

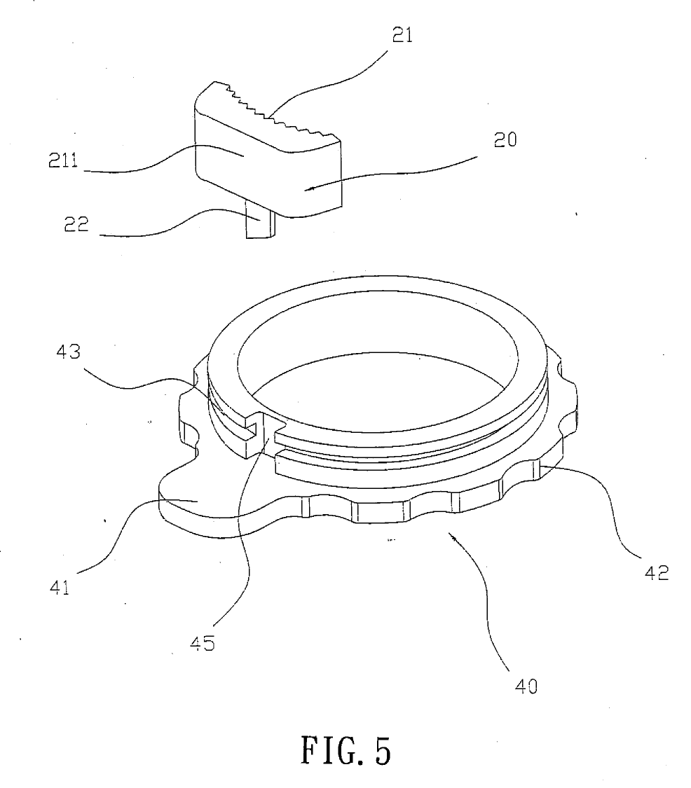

Further referring to FIGS. 2, 3, 4 showing how components of the present invention are assembled, the handle 10 is connected to the ratchet portion 13, in the adjustment recess 135 of the ratchet portion 13 is provided the spring 1352 and the push member 1351, the elastic member 1321 is disposed in the arc groove 134 of the ratchet portion 13, the adjustment member 20 is, as shown in FIG. 2, disposed in the arc groove 134 with the teeth 21 facing upwards and the resisting surface 211 resisting against the elastic member 1321 in the arc groove 134, the adjustment rod 22 of the adjustment member 20 is located in an upper end of the adjustment recess 135, and a lower end of the adjustment rod 22 resists against the push member 1351, the ratchet member 30 is disposed in the opening of the ratchet portion 13 in such a manner that the toothed surface 32 of the ratchet member 30 is located on the sliding surface 132 of the ratchet portion 13, and the smooth surface 31 is disposed at the positioning groove 131, the teeth 21 of the adjustment member 20 is engaged with the toothed surface 32 of the ratchet member 30, further, one side of the ratchet member 30 is restricted by the stop ring 133, in the locking groove 43 of the control member 40 is disposed the C-shaped clip 44, the control member 40 is installed in from one side of the positioning groove 131 and presses the C-shaped clip 44 to slide into the positioning groove 131, so that the control member 40 and the ratchet member 30 are restricted in the ratchet portion 13, additionally, the adjustment rod 22 of the adjustment member 20 is disposed in the limiting recess 45, as shown in FIG. 5.

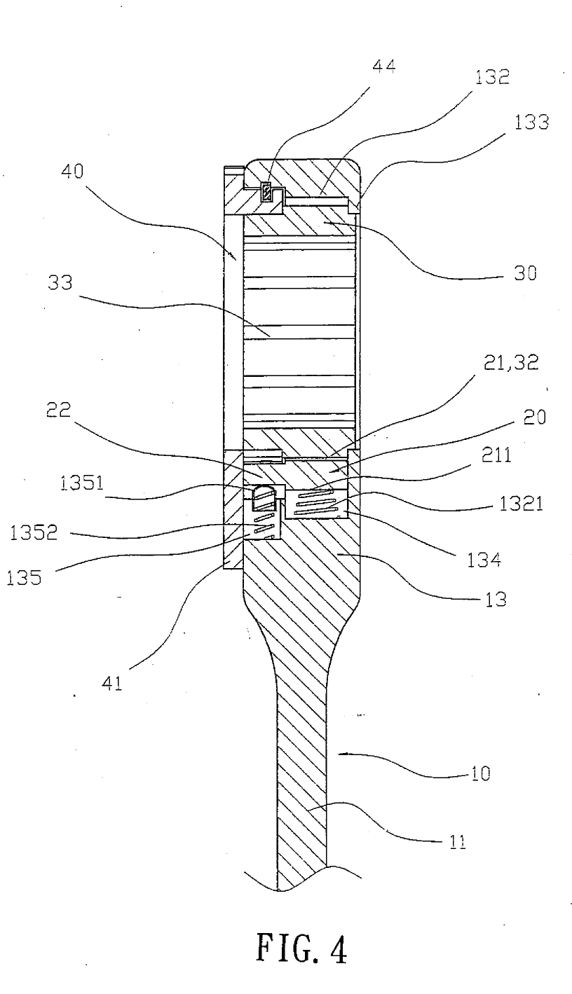

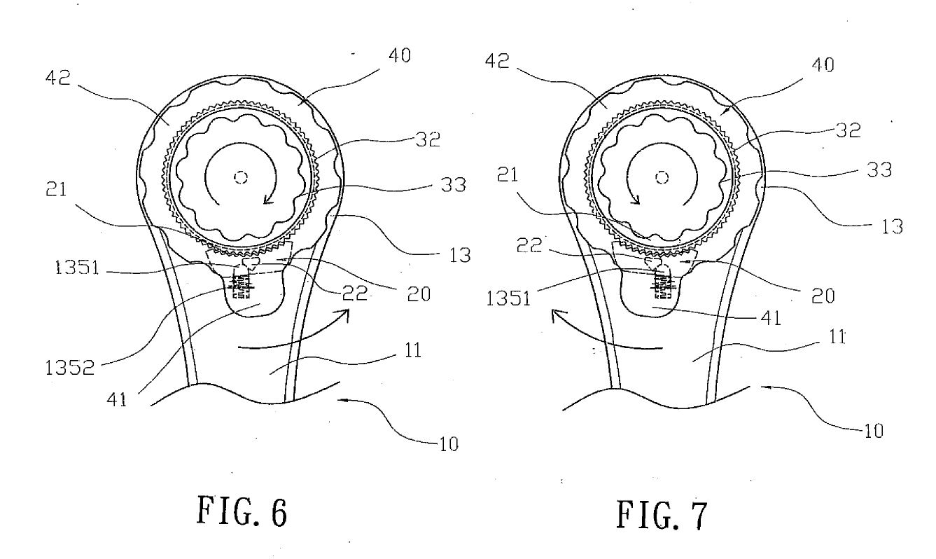

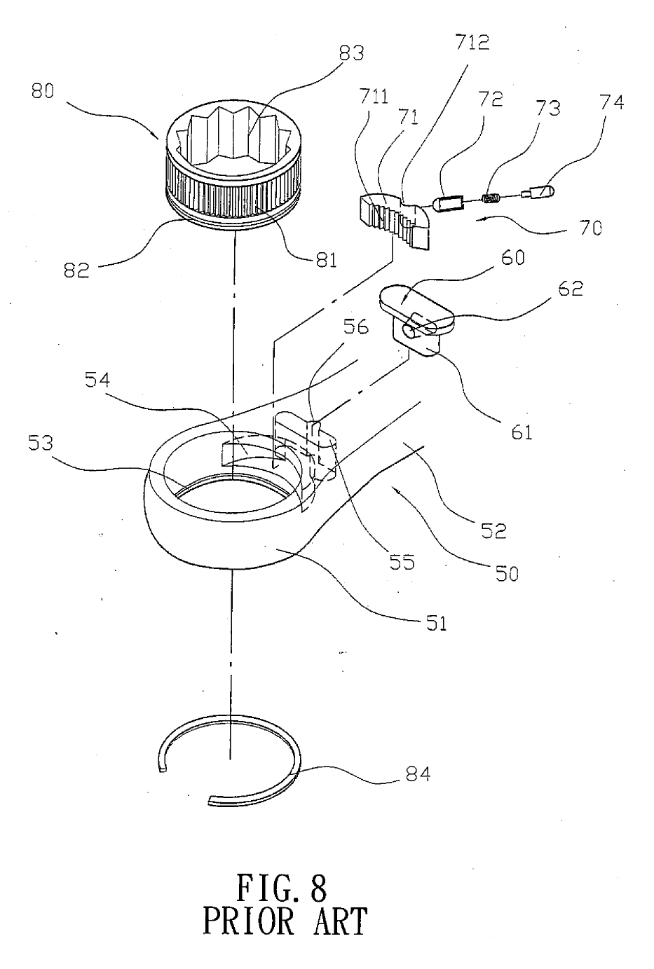

When in practical use, as shown in FIGS. 4, 5 and 6, the adjustment rod 22 of the adjustment member 20 can be controlled by both the control end 41 and the ring body 42, and with one of the two inclined surfaces of the adjustment rod 22 pressed against the push member 1351 located in the adjustment recess 135, the adjustment member 20 can be adjusted left or right, further, the engagement between the adjustment member 20 and the ratchet member 30 can also be improved. The elastic member 1321 in the arc groove 134 supports against the adjustment member 20 to keep contact between the teeth 21 of the adjustment member 20 and the toothed surface 32 of the ratchet member 30. The push member 1351 cooperates with the elastic member 1321 to increase the torque capacity of the ratchet member 30. When the control end 41 is turned right, since the adjustment rod 22 is engaged in the limiting recess 45, the adjustment member 20 will be turned right within the arc groove 134 of the ratchet portion 13 and then positioned against the push member 1351. At the same time, the teeth 21 of the adjustment member 20 are engaged with the toothed surface 32 of the ratchet member 30, and the adjustment member 20 is limited by the arc groove 134 and the elastic member 1321, so that when the handle is turned in the clockwise direction, the ratchet member 30 will not rotate in the counterclockwise direction, and thus the nut will be screwed in the clockwise direction. When being rotated in a reversed direction, namely in the clockwise direction, the ratchet member 30 will push the adjustment member 20 towards the center of the arc groove 134 to make the toothed surface 32 disengage from the teeth 21, so that when the handle 10 is turned in the counterclockwise direction, the ratchet member 30 will rotate along the sliding surface 132 without unscrewing the nut. In addition, when the control end 41 is turned left, the adjustment member 20 is limited at the left side of arc groove 134, so that the ratchet member 30 can also rotate in a single direction to unscrew the nut in the counterclockwise direction. The elastic member 1321 is disposed in the arc groove 134 and supports against the lower end of the adjustment member 20 to make the contact between the adjustment member 20 and the ratchet member 30 much closer, preventing the ratchet member 30 from rotating in both clockwise and counterclockwise directions.

While we have shown and described various embodiments in accordance with the present invention, it is clear to those skilled in the art that further embodiments may be made without departing from the scope of the present invention.

What is claimed is:

1. A control structure for a two-way ratchet tool comprising: a handle, an adjustment member, a ratchet member and a control member, characterized in that:
the handle includes a shank portion, a drive portion and a ratchet portion, the shank portion is connected between the drive portion and the ratchet portion, the drive portion is a turning end of a hand tool, the ratchet portion is an annular opening which is defined with a positioning groove in an inner periphery thereof and a sliding surface extending from the positioning groove inwards, at the other side of the sliding surface of the ratchet portion is provided a protruding stop ring, the sliding surface of the ratchet portion is defined with an arc groove adjacent to the shank portion for accommodation of an elastic member, the positioning groove of the ratchet portion is defined with an adjustment recess located close to the shank portion, in the adjustment recess is provided a push member and a spring, the adjustment member is an arc block provided with plural teeth on an upper end thereof and a resisting surface on a lower end thereof, the adjustment member is formed with an adjustment rod extending from one side thereof, and the adjustment rod is triangular in cross section, the ratchet member is an annular member formed with a smooth surface and a toothed surface on an outer periphery thereof, the ratchet member is further provided with a wavy engaging surface on an inner periphery thereof, the control member includes a ring body with a wavy outer surface and a control end extending from the ring body, the ring body is defined with a locking groove in one side thereof for accommodation of a C-shaped clip, the ring body is further defined with a limiting recess vertical to the locking groove in alignment with the control end;
when the control end is turned left or right, the adjustment member will be limited by the arc groove and the elastic member, so that the ratchet member is unable to rotate to achieve a function of turning a nut, with one of the two inclined surfaces of the adjustment rod pressed against the push member located in the adjustment recess, the adjustment member is allowed to be adjusted left or right, further, an engagement between the adjustment member and the ratchet member is improved, the elastic member is disposed in the arc groove and supports against the lower end of the adjustment member, the push member cooperates with the elastic member to increase a torque capacity of the ratchet member for preventing the ratchet member from rotating in both clockwise and counterclockwise directions.

2. The control structure for a two-way ratchet tool as claimed in claim 1, wherein the elastic member is a coil spring.

3. The control structure for a two-way ratchet tool as claimed in claim 1, wherein the elastic member is a leaf spring.

4. The control structure for a two-way ratchet tool as claimed in claim 1, wherein the elastic member is a rubber.

5. The control structure for a two-way ratchet tool as claimed in claim 1, wherein the adjustment member is disposed in the arc groove with the teeth facing upwards and presses against the elastic member in the arc groove.

6. The control structure for a two-way ratchet tool as claimed in claim 1, wherein the teeth of the adjustment member are engaged with the toothed surface of the ratchet member.

7. The control structure for a two-way ratchet tool as claimed in claim 1, wherein the adjustment rod of the adjustment member is disposed in the limiting recess of the control member.
